(19) United States
(12) Patent Application Publication
(10) Pub. No.: US 2012/0253871 A1
(43) Pub. Date: Oct. 4, 2012

(54) System and Method for Optimizing Allocation of Merchandising Resources and Pricing

(76) Inventors: Aidan D. Tracey, Oakville (CA); Robert L. Rae, JR., Plano, TX (US)

(21) Appl. No.: 13/079,230

(22) Filed: Apr. 4, 2011

(51) Int. Cl. G06Q 10/00

(52) U.S. Cl. 705/7.13

(57) ABSTRACT

A system and method of optimizing allocation of services and pricing for those services is described for group transactions having at least three distinct entities. The entities can include a retailer, a plurality of vendors in need of the services and a plurality of service providers who provide the services. The system and method include creating an allocation of services to be performed at the retailer by service providers on behalf of vendors, and a price schedule for the designated for services, and placing the allocation of the services up for commitment by the vendors in discrete increments. Final pricing is determined for the discrete increments of time, services or other discrete measure designated for services based on the amount of time committed to by the plurality of retailers, and schedules the services providers to provide the services on behalf of the vendors at the retailer.

### TECHNICAL FIELD

The present disclosure is directed to group purchasing and optimization systems, and more particularly to group transactions involving merchandising services that involve at least four different types of entities.

### BACKGROUND OF THE INVENTION

Merchandising is a term that can have different meanings in different contexts. In retail commerce, visual display merchandising can mean maximizing merchandise sales using product design, selection, packaging, pricing, and display that stimulates consumers to spend more. This includes disciplines in pricing and discounting, physical presentation of products and displays, and the decisions about which products should be presented to which customers at what time.

In the supply chain, merchandising can be the practice of making products in retail outlets available to consumers, primarily by stocking shelves and displays. While this used to be done exclusively by the stores' employees, many retailers have found substantial savings in requiring it to be done by the manufacturer, vendor, or wholesaler that provides the products to the retail store. In North America and Europe there are a number of organizations that supply merchandising services to support retail outlets with general stock replenishment and merchandising support in new stores. By doing this, retail stores have been able to substantially reduce the number of employees needed to run the store.

While stocking shelves and building displays is often done when the product is delivered, it is increasingly a separate activity from delivering the product. In grocery stores, for example, almost all products delivered directly to the store from a manufacturer or wholesaler will be stocked by the manufacturer's/wholesaler's employee who is a full time merchandiser. For some major manufacturers, particularly in the beverage and baked goods industries, their merchandisers are often the single largest employee group within the company.

Merchandising requirements are cyclical during the year and differ by season and holidays, with large requirements particularly around Christmas. Merchandising also varies within retail chains, with the same retailer stocking or promoting different items in stores in different parts of the country or even by neighborhood.

As described above, most of the merchandising, particularly in large box stores, is done now by the manufacturer or vendor instead of the retailer. In turn, the manufacturers and vendors have outsourced the actual work of merchandising to third party service providers who hire, manage, schedule and coordinate the human resources required to accomplish the merchandising tasks in stores. These third party service providers may be national, regional, or local and may vary in quality and capabilities. As a result, it is often difficult for retailers to manage the number and quality of the personnel entering their stores to perform merchandising services on behalf of their manufacturers.

### BRIEF SUMMARY OF THE INVENTION

In order to overcome the deficiencies of the current system, embodiments of the present invention make use of recent advances in internet based technologies that have allowed many products and services to begin to take advantage of the power of multiple unrelated buyers of a product or service to receive a discount by all agreeing to purchase that product or service at an agreed price or time. Purchasing co-operatives have existed for centuries, however, the internet now allows many more buyers to be involved and coordinated.

A purchasing and optimization system according to the concepts described herein will significantly enhance the way business is currently done in the merchandising industry and can be applied to any industry having three or more required participants. The system described herein allows three or more different groups to alter the way distributed services, such as retail merchandising services, are purchased. The three parties in the retail merchandising context are the retail location owner (retailer), the manufacturer or distributor of a product (vendor), and the service provider who will perform the merchandising service (service provider).

In a particular embodiment of the present system, a facilitator will create a proprietary database of retailer locations along with a preferably web based interface for vendors to indicate their desire to purchase retail merchandising services, referred to herein generally as “services,” at these retail locations. The facilitator working with one or more of the other parties, but in most cases with the vendors and service providers, will create a base price scenario for the service providers to perform defined services for the vendor community. As vendors from a broad range of categories all login to the facilitator's system to commit to a block of time, services or other discrete measure, the overall base price for the services can be made to decline for each vendor. The award of the services will be facilitated by the facilitator to allow for multiple potential pre-approved in-store service providers to effectively compete for the work. This list of approved service providers for a retailer is preferably determined by the retailer. This is of benefit to all three parties since the retailer gets higher quality and consistent in-store services, the vendor community gets the services at a better price, and the service provider is able to achieve economies of scale on the services to improve their business.

A system such as the one described herein can become an industry-wide platform for all retailers to deploy to the vendor community which will deliver industry-wide cost savings while improving conditions for consumers in terms of the in-store retail experience.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of the prior art system of selling, scheduling and performing merchandising services;

FIG. 2 is a block diagram of an embodiment according to the concepts described herein of a system to allow for multi-party bundling, sale and scheduling of merchandising services;

FIG. 3 is a flow chart illustrating an embodiment according to the concepts described herein of a process for multi-party bundling, sale and scheduling of merchandising services; and

FIG. 4 is a network diagram of an embodiment of a system according to the concepts described herein for implementing a multi-party merchandising system.

### DETAILED DESCRIPTION OF THE INVENTION

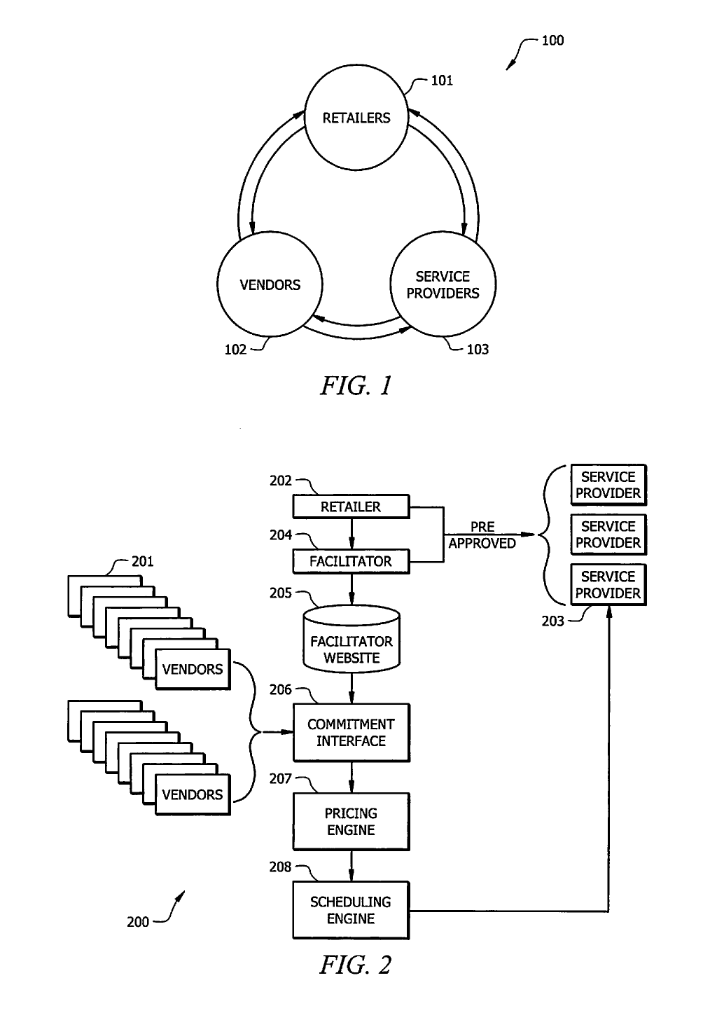

Referring now to FIG. 1, a figure illustrating the current method of allocating, purchasing and scheduling merchandising services is described. As described above, retailers have pushed the responsibilities for merchandising services onto the individual vendors/manufacturers for that vendor's products. Merchandising can include any or all of stocking store shelves with the appropriate merchandise, placing collateral to promote a vendor's products, setting up and removing special displays to promote the vendor's products, placing in-store personnel to promote the vendor's products, or any other service or action related to a vendor's products in a retailer's store.

In the current system 100, retailers 101 work with vendors 102 to allocate space and access to the stores. Retailers may often also need to qualify service providers 103 to ensure that the personnel entering the store are qualified and properly insured to work in the retailer's store. Service providers 103 need to coordinate services and vendors 102 and need to schedule time and access with retailers 101. As many retailers have hundreds of stores all across the country or continent, vendors must often work with multiple service providers. Further, store requirements may change according to the store location and store layout even within the same retailer. The current method of providing merchandising services is a very manual process and the quality at retail locations is not consistent.

Referring now to FIG. 2, an embodiment of a system for simplifying and optimizing the sale and delivery of merchandising services is described. System 200 includes a facilitator 204 who coordinates the needs and requirements of each of the vendors 201, retailers 202, and service providers 203. In preferred embodiments, the system is web-based through a website and database 205. A web-based system allows each of the participants to easily access the system and services using a conventional browser connected to the internet. Though preferred embodiments are web-based, any type of network could be used to connect the participants without departing from the scope of the concepts described herein. Facilitator website 205 includes a database that stores relevant information concerning the requirements and qualifications of each participant.

Retailers 202, through the facilitator 204 agree on merchandising allotments and schedules. Facilitator 204 puts the information into the database 205 and then allows vendors 201 to begin making commitments for service using the commitment interface 206. Vendor commitments may be based on any or all of a variety of factors, including blocks of time, services, access schedule, service provider, or any other factor to which the vendors and service providers can commit. Further, certain embodiments may be similar to existing group buying systems such as Groupon, (a group buying system is described in greater detail in U.S. Pat. No. 6,269,343 to Pallakoff, issued Jul. 31, 2001), in that the system 200 can adjust pricing or other factors based on the quantity of commitments placed by the vendors. This allows any of the parties, but in most embodiments the service providers, to set an initial offer price and a graduated discount based on the total commitments by the group of vendors.

Using blocks of time and prices as an example only, retailer may make merchandising time with a pre-approved group of service providers available to vendors on system 200. Blocks in 10 hour increments can be committed to by vendors for $50/hr. The price can be programmed to drop by $1/hr for each 100 hours committed to by vendors down to a minimum price of $35/hr. If vendors commit to 1,000 hours, each of the vendors will receive a price for services of $40/hr. While time and price have been used in the example, other criteria or requirements may be used by retailers or specified by vendors when making their commitments without departing from the scope of the concepts described herein.

Once the commitment process has closed, the commitments from the vendors are sent to the pricing engine 207 which determines the final price based on the discount schedule. A scheduling engine 208 can then be used to assign vendors to the pre-approved service providers 203. The service providers may be assigned on any number criteria, including skill sets, geographic availability, retailer access time, etc. Once the service providers are assigned, the vendors use the assigned service providers to perform the required merchandising within the retailer stores.

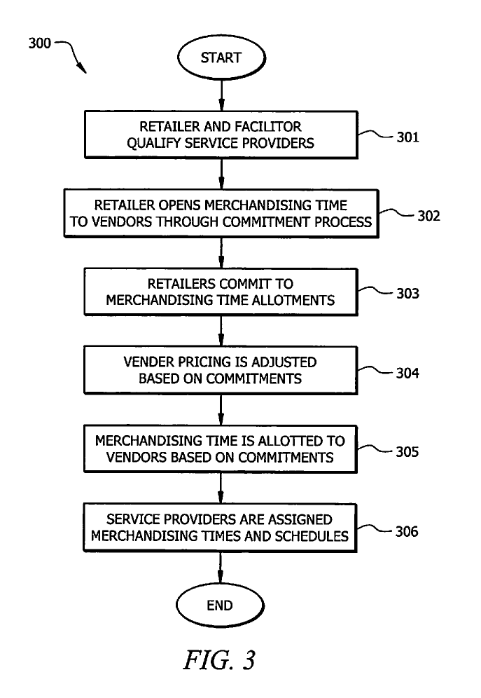

Referring now to FIG. 3, an embodiment of a process according to the concepts described herein is described. Process 300 can be used with systems such as that described with respect to FIG. 2 to create group buying opportunities to provide vendors with discounted merchandising services and optimization of the allocation of merchandising resources for service providers and retailers. Reference will be made to the entities described in FIG. 2.

The process begins with the parties working together to determine merchandising requirements, availability and pricing, as shown in block 301. In preferred embodiments, the service providers set the initial base price and discount schedule, the retailer sets store availability. The retailer and/or facilitator will also pre-qualify service providers that want to provide the merchandising services, or certain types of merchandising services. Each of the service providers will have available skill sets and resources that will be entered into the system and used to match a service provider with a vendor. Once the parties have collectively set the requirements and other parameters, process 300 moves to block 302. In block 302, the facilitator makes merchandising time, services, or other discrete measure available to vendors that need merchandising services with that retailer available for commitment by vendors using the facilitator's system. The vendors are then able to pre-commit, as shown in block 303, to certain amounts of guaranteed merchandising time, services or other discrete measure to be provided by the pre-qualified service providers at a set maximum price.

As described above, as the group of vendors pre-commit to a certain volume of merchandising with the retailer, the price of that merchandising can fall according to a pre-determined schedule or formula. The merchandising is preferably made available in set blocks of time, services or other discrete measure, such as 10 hours in the case of time. The vendors may, in certain embodiments, also set resource or skill requirements for the service providers who will ultimately perform the services.

Once the commitment period has closed, process 300 moves to block 304 where the final pricing is determined based on the amount of time, services or other discrete measure committed to by the vendors and the discount schedule or formula put in place by the service provider and/or facilitator. Next, the process moves to block 305 where the scheduling engine 208 from FIG. 2 is used to assign vendors and merchandising services and schedules to the service providers. The scheduling process takes into account vendor specified requirements, service provider skill sets and resource availability, retailer restrictions, requirements and access schedules, and any other factor as may be required. Once the scheduling engine matches and optimizes service provider resources to vendor and retailer requirements, the service providers are assigned merchandising times, schedules and tasks in block 306.

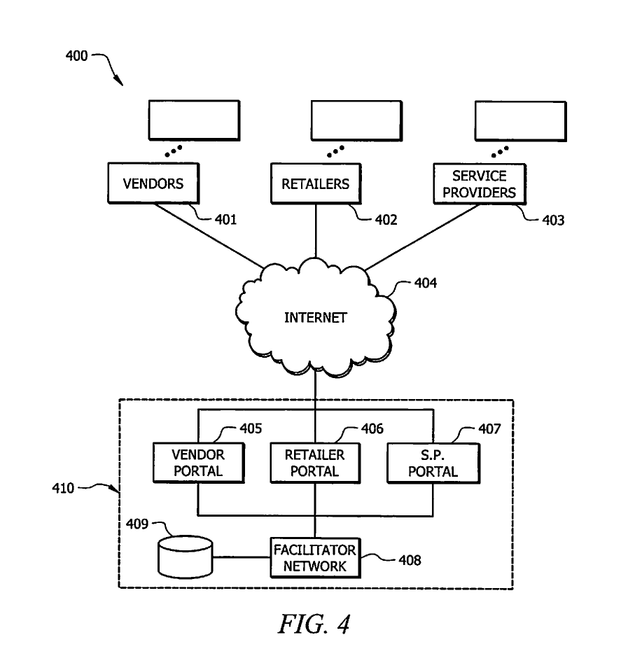

While a particular embodiment and process flow has been described with respect to FIG. 3, those skilled in the art will appreciate that variations and additions to the flow can be made while remaining well within the scope of the concepts described herein. Further, while FIGS. 2 and 3 have been shown and described with reference to a single retailer, the system and process shown in FIGS. 3 and 4 is intended to be replicated for an unlimited number of retailers without altering its operation, characteristics or requirements.

Referring now to FIG. 4, an embodiment of a network for employing a system such as is described herein is shown. Network 400 utilizes a web based design to allow all participants easy access to the facilitator system. Each of the vendors 401, retailers 402, and service providers 403 may connect to the facilitator system 410 using a web based interface over the Internet 404 or other network. Portals are designated for each of the types of entities that will access facilitator network 410, as shown by vendor portal 405, retailer portal 406 and service provider portal 407. The portals are configured to provide access to the facilitator system appropriate for each type of entity, allowing such entity to access its profile data, set or see commitment parameters, set or see restrictions or requirements, make commitments, or receive scheduling allotments and times, as appropriate for each entity.

Facilitator system 410 also includes facilitator network 408 and facilitator database 409. Facilitator network 408 includes the servers and programming used to implement the system described herein. Facilitator database 409 holds all of the profiles, data and requirements from each of the vendors 401, retailers 402, and service providers 403 using the facilitator system.

In certain embodiments of a purchasing and optimization system according to the concepts described herein, the retailer and/or facilitator can deduct a percentage or a fixed portion of the final price for the services as compensation for access to the system by the service providers. The service providers will know the pricing schedule and fee in advance and can determine their participation based on those known factors. In this scenario, the vendors are incented to use the system to get known access to the retailers and discounted service provider fees, the retailer benefits by getting a known pool of pre-qualified service providers and a fee for providing merchandising access, and the service providers get access to a guaranteed pool of work at a known discount structure.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for optimizing allocation of services and pricing for those services in three party group transactions, the parties including a retailer, a plurality of vendors and a plurality of service providers, the system comprising:
a database containing information related to the services and pricing for such services;
a commitment interface allowing the plurality of vendors to commit to desired services to be performed at the retailer;
a pricing engine to determine the final price for the services based on the commitments by the plurality of vendors; and
a scheduling engine to assign the services allocated to the plurality of vendors to particular service providers from the plurality of service providers and to schedule access to the retailer for each particular service provider assigned to perform the services.

2. The system of claim 1 wherein commitments for the desired services are incremented in blocks of access time to the retailer.

3. The system of claim 1 wherein the pricing engine is operable to reduce the cost to each of the plurality of committing vendors for the services as the plurality of committing vendors as a group commit to additional services.

4. The system of claim 1 wherein the system is provided by a facilitator.

5. The system of claim 4 wherein the facilitator works with the retailer and service providers to create the database.

6. The system of claim 4 wherein the facilitator is compensated by receiving a percentage of the services sold using the system.

7. The system of claim 1 wherein the retailer has multiple, geographically diverse locations that require the services.

8. The system of claim 1 wherein the plurality of service providers are preapproved by the retailer.

9. The system of claim 1 wherein the retailer, the plurality of vendors and the plurality of service providers access the system over the internet.

10. The system of claim 1 wherein the scheduling engine uses information on each of the plurality of service providers in matching the service provider with the services required by a particular vendor.

11. A method of optimizing allocation of services and pricing for those services in three party group transactions, the parties including a retailer, a plurality of vendors and a plurality of service providers, the method comprising:
creating an allocation of designated for services and a price schedule for the designated for services;
placing the allocation of designated for services up for commitment by the plurality retailers in discrete increments;
determining the final pricing for the discrete increments of services based on the commitments by the plurality of vendors; and
scheduling the service providers to provide the services on behalf of the vendors at the retailer.

12. The method of claim 11 wherein the service providers are preapproved by the retailer.

13. The method of claim 11 wherein the method is operable to reduce the cost to each of the plurality of committing vendors for the services, as the plurality of committing vendors as a group commit to additional services.

14. The method of claim 11 further comprising a facilitator operable to provide an interface to the retailer, the plurality of vendors and the plurality of service providers.

15. The system of claim 14 wherein the retailer, the plurality of vendors and the plurality of service providers access the facilitator interface over the internet.

16. The method of claim 14 wherein the facilitator works with the retailer and service providers to create a database containing information on each service providers.

17. The method of claim 16 wherein the information on each service provider includes types of services provided, geographic limitations, and special skills.

18. The system of claim 17 wherein the scheduling engine uses the information on each of the service providers to match the service provider with the services required by a particular vendor.

19. The method of claim 14 wherein the facilitator is compensated by receiving a percentage of the services sold using the system.

20. A system for optimizing allocation of services and pricing for those services in group transactions, the parties including a facilitator, a retailer, a plurality of vendors and a plurality of service providers, the system comprising:
a facilitator network comprising:
a database containing information related to each of the plurality of service providers, the services to be provided to the retailer and pricing for such services;
a commitment interface accessible by the plurality of vendors and allowing the plurality of vendors to commit to desired services to be performed at the retailer;
a pricing engine to determine the pricing for the services for each of the plurality of committing vendors based on the collective commitments by the plurality of vendors; and
a scheduling engine to assign the services allocated to the plurality of committing vendors to particular service providers from the plurality of service providers based on the service provider information in the database and to schedule access to the retailer for each particular service provider assigned to perform the services.

21. The system of claim 20 wherein the retailer, the plurality of vendors and the plurality of service providers access the facilitator network over the internet.

22. The system of claim 20 wherein the facilitator is compensated by receiving a percentage of the services sold using the system.

23. The system of claim 20 wherein the retailer has multiple, geographically diverse locations that require the services.

24. The system of claim 20 wherein the plurality of service providers are preapproved by the retailer.

25. The system of claim 20 wherein commitments for the desired services are incremented in blocks of access time to the retailer.
